(19) United States
(12) Patent Application Publication
(10) Pub. No.: US 2014/0293069 A1
(43) Pub. Date: Oct. 2, 2014

(54) REAL-TIME IMAGE CLASSIFICATION AND AUTOMATED IMAGE CONTENT CURATION

(71) Applicant: Microsoft Corporation, (US)

(72) Inventors: Filip Lazar, Redmond, WA (US); Kevin Zhu, Redmond, WA (US); Greg Edmiston, Redmond, WA (US); Julie Kohler, Redmond, WA (US); Azure Zhu, Redmond, WA (US); Omar Shahine, Redmond, WA (US); Seung-Hae Park, Redmond, WA (US); Ryan Hoge, Redmond, WA (US)

(73) Assignee: Microsoft Corporation, Redmond, WA (US)

(21) Appl. No.: 13/855,644

(22) Filed: Apr. 2, 2013

(51) Int. Cl. G06K 9/62; H04N 1/00; G06K 9/00; H04N 5/232; G06K 9/46; G06K 9/18

(52) U.S. Cl. CPC G06K 9/6267; G06K 9/46; G06K 9/4652; G06K 9/18; G06K 9/6202; G06K 9/00288; H04N 5/23293; H04N 1/00204
USPC 348/207.1; 382/190; 382/165; 348/333.02

(57) ABSTRACT

The present disclosure describes real-time image classification and automated image content curation. An image is uploaded to a database of a real-time image classification system after its capture using an image capture device. The real-time image classification system automatically determines a classification for the image in real-time based on a feature optically extracted from the image using an optical recognition module. The classification is associated with the image in the database and transmitted to the image capture device for display together with the image.

### TECHNICAL FIELD

This disclosure pertains to real-time image classification and automated image content curation.

### BACKGROUND

The automatic classification of images has become increasingly useful as the use of digital image capture devices, e.g., mobile or other computing devices including a digital camera, grows. Unlike traditional film roll cameras, digital cameras capture as many images as the size of the memory used to store the images permits. The result is a large number of images stored in the memory of the digital cameras that renders daunting the task of identifying a particular image or a particular type or category of image.

Most applications executing on mobile or other computing devices require a user to manually classify images before or after the digital camera captures the image. In one instance, an exemplary application executing on a mobile or other computing device does not allow any classification of images whatsoever before the image stream is shared with other devices. In another instance, an application executing on a mobile or other computing device allows manually captioning an image after the image is captured and before the image is shared with other devices. In neither instance does the application automatically classify the image without requiring manual intervention.

A user may use a search engine to search through images stored on a memory in mobile and other computing devices. Although the search engine may be implemented in a combination of hardware and software, rapid image categorization is difficult to perform effectively, efficiently, and consistently, especially in a real-time environment. Automatically classifying images in an intuitive and well-organized manner simplifies subsequent retrieval of the images.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A real-time image classification system is configured to receive an image uploaded from an image capture device and to store the image in a database. The real-time image classification system invokes a plurality of classification modules, each classification module configured to optically extract particular metrics, features, or markers from the image. For example, an optical character recognition module is configured to detect text in the image and a face recognition module is configured to detect at least a portion of a face in the image. Likewise, color recognition module is configured to detect predominance of a particular color, color saturation recognition module is configured to detect color saturation, and blur recognition module is configured to detect blur in the image. The real-time image classification system automatically determines a classification corresponding to the image based at least in part on the any metric, feature, or marker extracted from image by each of the classification modules. The real-time image classification system associates the classification with the image in the database. By doing so, the real-time image classification system may classify all of the images in groups, e.g., data, life memories, and junk, which can be later searched to identify the specific image sought. In an embodiment, the real-time image classification system may search remote storage for the image in response to receiving a search query from the image capture device or other computing device, which, in turn, may display the image together with the classification on the image capture device or other computing device.

Additional aspects and advantages of exemplary systems and method of real-time image classification and automated image content curation will be apparent from the following detailed description that proceeds with reference to the accompanying drawings.

### DRAWINGS DESCRIPTION

FIG. 1A is a block diagram of an exemplary system for capturing an image.

FIG. 1B is a block diagram of an exemplary system for real-time image classification and automated content curation.

FIG. 2 is a flowchart of an exemplary method for real-time image classification and automated content curation.

FIG. 3 is flowchart of an exemplary method for determining a classification for an image.

FIG. 4 is a block diagram of an exemplary system for implementing a real-time image classification and automated content curation system.

### DETAILED DESCRIPTION

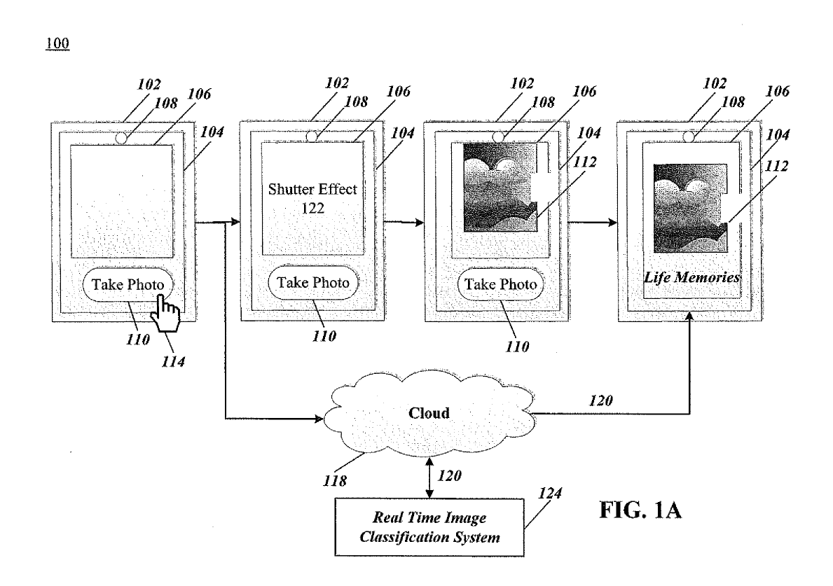

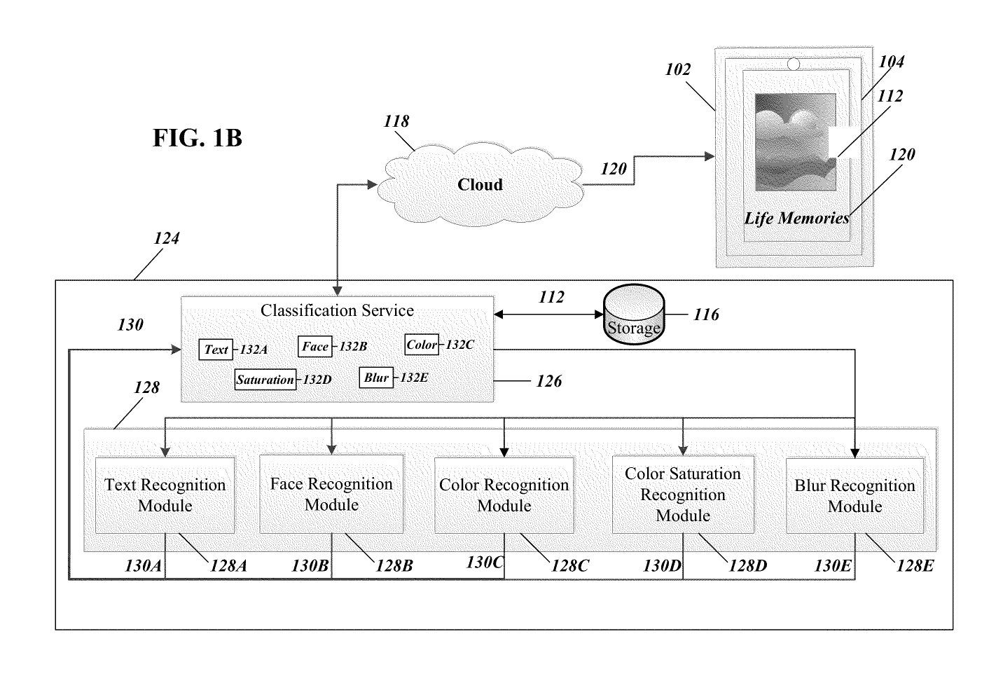

Referring to FIG. 1A, an exemplary image capture system 100 for capturing an image for storage and subsequent processing includes a digital image capture device 102 comprising a digital camera 104 having a screen 106, a lens 108, and an actuation button 110. Digital image capture device 102 may be any computing device including digital camera 104 that is capable of digitally capturing an image.

Digital image capture device 102 may include a general purpose or personal computer, tablet computing devices, laptop computing devices, hand-held devices, mobile communication devices, multi-processor systems, microprocessor-based or programmable consumer electronics, minicomputers, mainframe computers, and like that include camera 104 capable of capturing digital images.

Digital camera 104 includes circuitry to capture image 112 in which lens 108 focuses light on a sensor (not shown) in response to actuation of actuation button 110 by a user 114. The sensor records image 112 to a local storage device (not shown), e.g., a memory, and digital camera 104 renders or displays image 112 on screen 106. Digital camera 104 may also include circuitry to record a moving video and attendant sound. Digital camera 104 may be implemented in hardware, software, or a combination of hardware and software. In an embodiment, lens 108 may be a hardware lens while actuation button 110 may be implemented in software such that it is displayed on screen 106 and actuated by a finger touch of user 114 as is well known to a person of ordinary skill in the art. Digital camera 104 as well as the sensor and other supporting circuitry are well known to a person of ordinary skill in the art and will not be described in any further detail herein.

Digital image capture device 102 may upload image 112 to remote storage 116 accessed through a network 118 for storage and processing. Network 118 may represent a distributed computing system, e.g., a computing cloud, in which various computing entities or devices, often geographically remote from one another perform particular tasks or execute particular objects, components, routines, programs, instructions, data structures, and the like. For example, image capture system 100 and a real-time image classification system 124 (FIG. 1B) may be implemented in a server/client configuration (e.g., digital image capture device 102 may operate as a client when seeking real-time image classification from real-time image classification system 124, which, in turn, operates on a server).

Referring to FIG. 1B, an exemplary real-time image classification system 124 includes a real-time image classification service 126, remote storage 116, and classification modules 128. Image classification system 124 may receive image 112 from digital image capture device 102 substantially simultaneously or sequentially to digital image capture device 102 displaying a shutter effect 122 or image 112 on screen 106. Image classification system 124 may be a program or a module that includes objects, components, routines, programs, instructions, data structures, and the like that perform particular tasks functions. Some or all of the programs or modules may be instantiated at run time by a processing device or a computing device. A person of ordinary skill in the art will recognize that many of the concepts associated with the exemplary embodiment of real-time classification system 124 may be implemented as computer instructions, firmware, or software that are stored in any of a variety of computer readable storage mediums and executed on any of a variety of computing architectures.

Image classification system 124 may automatically store image 112 in remote storage 116 without manual intervention. Image classification system 124 may store image 112 in any known image file format, including JPEG/JFIF (Joint Photographic Experts Group/JPEG File Interchange Format), Exif (Exchangeable Image File format), RAW, TIFF (Tagged Image File Format), GIF (Graphics Interchange Format), BMP (Bitmap), PNG (Portable Network Graphics), PPM (Portable Pixmap), PGN (Portable Graymap), PBM (Portable Bitmap), WebP, PCX (Personal Computer Exchange), and the like.

While remote storage 116 may be geographically remote from digital image capture device 112, it may be geographically local to or remote from classification service 124. Remote storage 116 may be any kind of memory known to a person of ordinary skill in the art including random access memory (RAM), flash memory, read only memory (ROM), ferroelectric RAM, magnetic storage devices, optical discs, and the like. Image classification service 124 may automatically store image 112 in remote storage 116 as part of a database (not shown) to allow for the efficient organization, management, and retrieval of multiple images including image 112. Image classification service 124 may store the image 112 as well as other information associated with the image, e.g., classification 120 and metadata (not shown). Metadata may include date, time, and other settings of digital image capture device 102 at the time digital image capture device 102 captured image 112. As is well known to a person or ordinary skill in the art, a database is a structure or organized set of data stored in remote storage 116 that are accessible in various ways.

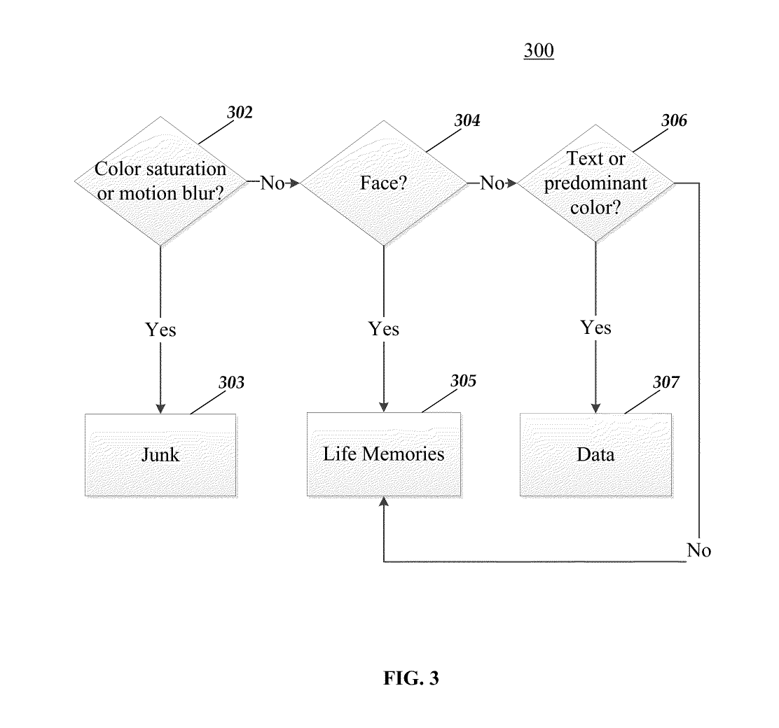

Image classification system 124 may automatically classify image 112 without manual intervention. To do so, image classification service 126 may invoke or otherwise call classification modules 128 that analyze image 112. Classification modules 128 may optically extract particular metrics, features, or markers from image 112 to generate recognition signals 130 that are provided to image classification system 124, in turn, to determine a classification 120 of image 112 using a classification method, e.g., automatic classification method 300 shown in FIG. 3. Classification modules 128 may include any number or type of recognition modules that are well known to a person of ordinary skill in the art.

Exemplary classification modules include character recognition module 128A, face recognition module 128B, color recognition module 128C, color saturation recognition module 128D, blur recognition module 128E, and the like. Character recognition module 128A may be configured to optically recognize any kind or type of text in image 112. In an embodiment, character recognition module 128A may be able to recognize text as a percentage of total content in image 112. The optical recognition of text in an image is well known to a person of ordinary skill in the art and will not be discussed in any further detail herein.

Face recognition module 128B may be configured to recognize facial features in image 112. Face recognition module 128B may employ algorithms that identify facial features in image 112. For example, face recognition module 128B may analyze the relative position, size, and/or shape of the eyes, nose, cheekbones, and jaw. Face recognition module 128B may apply templates and/or statistics to a set of salient facial features to determine the existence of a human or other face in image 112. The optical recognition of facial features in an image is well known to a person of ordinary skill in the art and will not be discussed in any further detail herein.

Color recognition module 128C, as the name implies, may be configured to determine a predominant color in image 112, e.g., black, white, or any other color, to thereby indicate that image 112 was taken in error or is otherwise unusable. Likewise, color saturation recognition module 128D may be configured to recognize color saturation in image 112. Color saturation recognition module 128D may be configured to recognize if the perceived intensity of any color in image 112 exceeds a predetermined threshold to thereby indicate that image 112 was taken in error or is otherwise unusable.

Blur recognition module 128E may be configured to recognize blur in image 112. Blur recognition module 128E may be configured to determine if the amount of blur in image 112 exceeds a predetermined threshold to thereby indicate that image 112 was taken in error or is otherwise unusable. The optical recognition of various markers or attributes in image 112, including recognizing a predominance of a particular color, color saturation, and blur in an image is well known to a person of ordinary skill in the art and will not be discussed in any further detail herein.

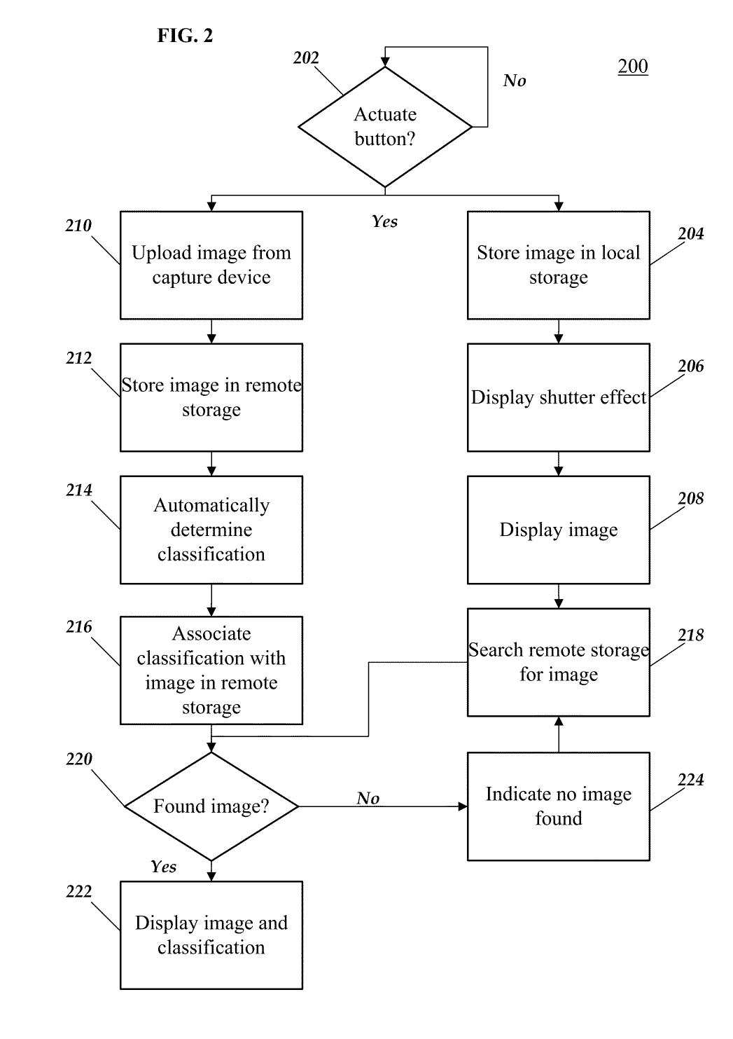

FIG. 2 is a flowchart of an exemplary method 200 for capturing and rendering image 112 on digital image processing device 102 and classifying image 112 using real-time image classification system 124. Referring to FIGS. 1A, 1B, and 2, at 202, digital image capture device 102 determines if user 114 actuated or otherwise activated actuation button 110 to capture image 112. Actuation of button 110, in turn, may activate a shutter that focuses light on a sensor (not shown) in digital image capture device 102. If user 114 actuates button 110, at 204, digital image capture device 102 may store image 112 in local storage (not shown), e.g., memory. At 206, digital image capture device 102 may optionally display shutter effect 122 on screen 106. At 208, digital image capture device 102 may render or otherwise display image 112 on screen 106.

Substantially simultaneously with storing image 112 in local storage at 204, digital image capture device 102 may upload image 112 to image classification system 124 at 210 for storage in remote storage 116 at 212. Digital image capture device 102 may upload image 112 and, optionally, metadata associated with image 112, to image classification system 124 using any manner of wired communications, wireless communications, cellular communications, or other communications mechanisms. In an embodiment, digital image capture device 102 may upload image 112 to image classification system 124 based at least in part on a predetermined setting of digital image capture device 102 that enables the upload of image 112 to remote storage 116 upon actuation of button 110. In another embodiment, digital image capture device 102 may upload image 112 to image classification system 124 based at least in part on upon receipt of an instruction to do so from user 114.

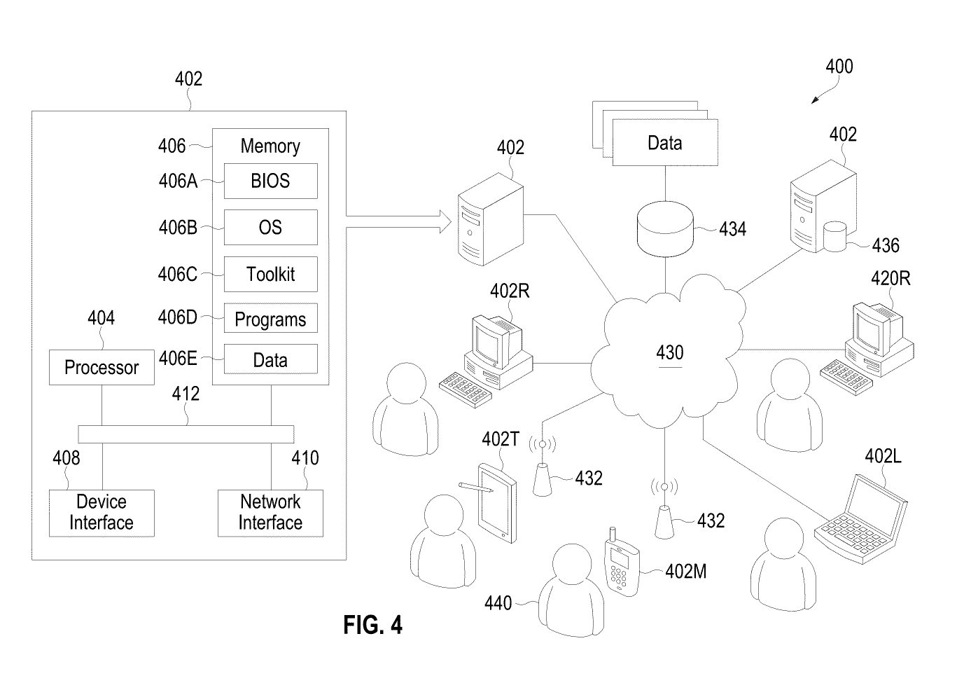

At 214, image classification system 124 may automatically determine a classification 120 for image 112 as is explained below in more detail with reference to FIG. 3. At 216, image classification system 124 may associate classification 120 with image 112 in e.g., a database, in remote storage 116. At 218, digital image capture device 102 or any other computing device 402 (FIG. 4) may activate image classification system 124 and access remote storage 116 to search for image 112. At 220, image classification system 124 may search remote storage 116 for image 112 in response to the search query received from digital image capture device 102 or computing device 402. If image classification system 124 locates image 112, image classification system 124 may enable or otherwise cause display of image 112 and classification 120 on digital image capture device 102 or computing device 402 at 222. In one embodiment, image classification system 124 may display image 112 and classification 120 from remote storage 116. In another embodiment, image classification system 124 may alternatively transmit classification 120 and associate image 112 stored in local storage, e.g., digital image capture device 102's camera roll, with classification 120 such that digital image capture device 102 displays image 112 and classification 120 directly from local storage (not shown). At 224, image classification system 124 may indicate to digital image capture device 102 or computing device 402 that the search did not result in locating image 112 so that a new search may begin at 218.

FIG. 3 is flowchart of an exemplary automatic classification method 300 for automatically determining a classification 120 for image 112 based at least in part on signals 130 generated by recognition modules 128. Referring to FIGS. 1A, 1B, 2, and 3, image classification service 126 may automatically classify image 112 into classification 120 from any number of predetermined classifications, e.g., Junk 303, Data 307, and Life Memories 305. Junk 303 may be configured to classify image 112 as unusable, corrupted, or otherwise lacking in value, photographic or otherwise. Data 307 may be configured to classify image 112 as comprising text or other useful information or data. Data 307 may be configured to classify image 112 when image 112 will be used to recollect information, e.g., this is where I parked this morning, to record a list of action items, e.g., buy milk, and to compare items offered for purchase, e.g., door at Home Depot® $699. Life Memories 305 may be configured to classify image 112 as a record of an experience, e.g., images of a city visited during vacation, images of sporting events attended, and the like. Life Memories 305 may be configured to classify image 112 that has not been classified as Junk 303 or Data 307. A person of ordinary skill in the art may recognize that classification 120 may include any number or category of classifications, including e.g., Junk 303, Data 307, and Life Memories 305.

Image classification service 126 may be configured to automatically determine classification 120 without manual intervention by invoking or otherwise calling classification modules 128 based at least in part on having completed uploading image 112 to remote storage 116. Classification modules 128 may optically extract particular metrics, features, or markers from image 112 to generate recognition signals 130 that allow image classification service 126 to automatically determine a classification 120 of image 112. Classification modules 128 may operate sequentially or in parallel. Image classification service 126 can evaluate recognition signals 130, individually or combined, using a variety of algorithms optimized to the requirements of digital image capture device 102, image classification system 124, or a combination of both. Image classification service 126 may evaluate recognition signals 130 to optimize performance, availability, security and other like attributes associated with the classification 120 of image 112.

At 302, image classification service 126 may compare the color saturation of image 112 as indicated by color saturation signal 130D output from color saturation recognition module 128D to a predetermined color saturation threshold 132D. Color saturation threshold 132D may be set or changed at any time to improve performance of image classification service 126. In an embodiment, color saturation threshold 132D may be set to a predetermined percentage of the total content of image 112. If color saturation signal 130D indicates that the color saturation of image 112 exceeds color saturation threshold 132D, image classification service 126 may classify image 112 as Junk at 303.

At 302, image classification service 126 may compare a predominant color in image 112 as indicated by color signal 130C output from color recognition module 128C to a predetermined color threshold 132C. Color threshold 132C may be set or changed at any time to improve performance of image classification service 126. In an embodiment, color threshold 132C may be set to a predetermined percentage of the total content of image 112. If color signal 130C indicates that a predominant color of image 112 exceeds color threshold 132C, image classification service 126 may classify image 112 as Junk at 303.

At 302, image classification service 126 may compare blur in image 112 as indicated by blur signal 130E output from blur recognition module 128E to a predetermined blur threshold 132E. Blur threshold 132E may be set or changed at any time to improve performance of image classification service 126. In an embodiment, blur threshold 132E may be set to a predetermined percentage of the total content of image 112 or to a level of blur in image 112 relative to an average acceptable level of blur in image 112. If blur signal 130E indicates that the blur of image 112 exceeds blur threshold 132E, image classification service 126 may classify image 112 as Junk at 303. Image classification service 126 may evaluate blur signal 130E as an alternative to in conjunction with at least one of color saturation signal 130D and color signal 130C in image 112 to determine whether image 112 may be classified as Junk at 303.

At 304, image classification service 126 may compare existing facial features in image 112 as indicated by face recognition signal 130B output from face recognition module 128D to a predetermined face threshold 132B. Face threshold 132B may be set or changed at any time to improve performance of image classification service 126. If face recognition signal 130B indicates that at least a portion of a face exists in image 112 thus exceeding face threshold 132B, image classification service 126 may classify image 112 as Life Memories at 305. Image classification service 126 may determine the existence of any manner or portion of at least one face, human or otherwise.

At 306, image classification service 126 may compare text in image 112 as indicated by text recognition signal 130A output from text recognition module 128A to a predetermined text threshold 132A. Text threshold 132A may be set or changed at any time to improve performance of image classification service 126. If text recognition signal 130A indicates that text in at least a portion of image 112 exceeds text threshold 132A, image classification service 126 may classify image 112 as Data at 307. Text recognition signal 130 may indicate any text in image 112, or some percentage of text in image 112. A person of ordinary skill in the art may recognize that image classification service 126 may use any manner of algorithm to determine classification 120 of image 112.

User 114 may search the database in remote storage 116 in any number of manners to quickly identify and retrieve images 112 that meet the particular search criteria. User 114 may use digital image capture device 102 or any other computing device 402 to enable image classification system 124 and access remote storage 116. For example, user 114 may determine the search criteria to be any image 112 having a Data 307 category. Since image classification system 124 automatically associates classification 120 with image 112, identification and retrieval of images classified as Data 307 from remote storage 116 is fast, efficient, and simple.

FIG. 4 is a block diagram of a system 400 for implementing an exemplary embodiment of image capture system 100, real-time image classification system 124, or a combination of both system 100 and system 124. Referring to FIG. 4, system 400 includes a computing device 402, e.g., digital image capture device 102 or real-time image classification service 126 shown in FIGS. 1A and 1B. Computing device 402 may execute instructions of application programs or modules stored in system memory, e.g., memory 406. The application programs or modules may include objects, components, routines, programs, instructions, data structures, and the like that perform particular tasks functions or that implement particular abstract data types. Some or all of the application programs may be instantiated at run time by a processing device 404. A person of ordinary skill in the art will recognize that many of the concepts associated with the exemplary embodiment of system 400 may be implemented as computer instructions, firmware, or software in any of a variety of computing architectures, e.g., computing device 402, to achieve a same or equivalent result.

Moreover, a person of ordinary skill in the art will recognize that the exemplary embodiment of system 400 may be implemented on other types of computing architectures, e.g., general purpose or personal computers, hand-held devices, mobile communication devices, multi-processor systems, microprocessor-based or programmable consumer electronics, minicomputers, mainframe computers, application specific integrated circuits, and like. For illustrative purposes only, system 400 is shown in FIG. 4 to include computing devices 402, geographically remote computing devices 402R, tablet computing device 402T, mobile computing device 402M, and laptop computing device 402L. A person of ordinary skill in the art may recognize that an exemplary digital image capture device 102 may include, e.g., computing device 402, tablet computing device 402T, mobile computing device 402M, and laptop computing device 402L. Similarly, a person of ordinary skill in the art may recognize that real-time image classification service 126 may be implemented in computing device 402, geographically remote computing devices 402R, and the like.

Similarly, a person of ordinary skill in the art will recognize that an exemplary embodiment of system 400 may be implemented in a distributed computing system in which various computing entities or devices, often geographically remote from one another, e.g., computing device 402 and remote computing device 402R, perform particular tasks or execute particular objects, components, routines, programs, instructions, data structures, and the like. For example, the exemplary embodiment of system 400 may be implemented in a server/client configuration (e.g., computing device 402 may operate as a server and remote computing device 402R may operate as a client). In distributed computing systems, application programs may be stored in local memory 406, external memory 436, or remote memory 434. Local memory 406, external memory 436, or remote memory 434 may be any kind of memory known to a person of ordinary skill in the art including random access memory (RAM), flash memory, read only memory (ROM), ferroelectric RAM, magnetic storage devices, optical discs, and the like.

The computing device 402 comprises processing device 404, memory 406, device interface 408, and network interface 410, which may all be interconnected through bus 412. The processing device 404 represents a single, central processing unit, or a plurality of processing units in a single or two or more computing devices 402, e.g., computing device 402 and remote computing device 402R. The local memory 406, as well as external memory 436 or remote memory 434, may be any type memory device including any combination of RAM, flash memory, ROM, ferroelectric RAM, magnetic storage devices, optical discs, and the like. The local memory 406 may include a basic input/output system (BIOS) 406A with routines to transfer data, including data 406E, between the various elements of system 400. The local memory 406 also may store an operating system (OS) 406B that, after being initially loaded by a boot program, manages other programs in the computing device 402. The local memory 406 may store routines or programs, e.g., application 406C, and/or the programs or applications 406D generated using application 406C. Application 406C may make use of the OS 406B by making requests for services through a defined application program interface (API). Application 406C may be used to enable the generation or creation of any application program designed to perform a specific function directly for a user or, in some cases, for another application program. Examples of application programs include word processors, database programs, browsers, development tools, drawing, paint, and image editing programs, communication programs, and tailored applications as the present disclosure describes in more detail, and the like. Users may interact directly with the OS 406B through a user interface such as a command language or a user interface displayed on a monitor (not shown).

Device interface 408 may be any one of several types of interfaces. The device interface 408 may operatively couple any of a variety of devices, e.g., hard disk drive, optical disk drive, magnetic disk drive, or the like, to the bus 412. The device interface 408 may represent either one interface or various distinct interfaces, each specially constructed to support the particular device that it interfaces to the bus 412. The device interface 408 may additionally interface input or output devices utilized by a user to provide direction to the computing device 402 and to receive information from the computing device 402. These input or output devices may include voice recognition devices, gesture recognition devices, keyboards, monitors, mice, pointing devices, speakers, stylus, microphone, joystick, game pad, satellite dish, printer, scanner, camera, video equipment, modem, monitor, and the like (not shown). The device interface 408 may be a serial interface, parallel port, game port, firewire port, universal serial bus, or the like.

A person of ordinary skill in the art will recognize that the system 400 may use any type of computer readable medium accessible by a computer, such as magnetic cassettes, flash memory cards, compact discs (CDs), digital video disks (DVDs), cartridges, RAM, ROM, flash memory, magnetic disc drives, optical disc drives, and the like. A computer readable medium as described herein includes any manner of computer program product, computer storage, machine readable storage, or the like.

Network interface 410 operatively couples the computing device 402 to one or more remote computing devices 402R, tablet computing devices 402T, mobile computing devices 402M, and laptop computing devices 402L, on a local or wide area network 430. Computing devices 402R may be geographically remote from computing device 402. Remote computing device 402R may have the structure of computing device 402, or may operate as server, client, router, switch, peer device, network node, or other networked device and typically includes some or all of the elements of computing device 402. Computing device 402 may connect to the local or wide area network 430 through a network interface or adapter included in the interface 410. Computing device 402 may connect to the local or wide area network 430 through a modem or other communications device included in the network interface 410. Computing device 402 alternatively may connect to the local or wide area network 430 using a wireless device 432. The modem or communications device may establish communications to remote computing devices 402R through global communications network 430. A person of ordinary skill in the art will recognize that application programs 406D or modules 406C might be stored remotely through such networked connections.

The present disclosure may describe some portions of the exemplary system using algorithms and symbolic representations of operations on data bits within a memory, e.g., memory 406. A person of skill in the art will understand these algorithms and symbolic representations as most effectively conveying the substance of their work to others of ordinary skill in the art. An algorithm is a self-consistent sequence leading to a desired result. The sequence requires physical manipulations of physical quantities. Usually, but not necessarily, these quantities take the form of electrical or magnetic signals capable of being stored, transferred, combined, compared, and otherwise manipulated. For simplicity, the present disclosure refers to these signals as bits, values, elements, symbols, characters, terms, numbers, or like. The terms are merely convenient labels. A person of skill in the art will recognize that terms such as computing, calculating, generating, loading, determining, displaying, or like refer to the actions and processes of a computing device, e.g., computing device 402. The computing device 402 may manipulate and transform data represented as physical electronic quantities within a memory into other data similarly represented as physical electronic quantities within the memory.

A person of ordinary skill in the art will recognize that they may make many changes to the details of the above-described exemplary systems and methods without departing from the underlying principles. Only the following claims, therefore, define the scope of the exemplary systems and methods.

1. A computer-implemented method, comprising:
storing an image in a database;
invoking a plurality of classification modules;
automatically determining a classification for the image based at least in part on at least one of the plurality of classification modules extracting a feature from the image; and
associating the classification with the image in the database.

2. The computer-implemented method of claim 1, further comprising:
uploading the image to the database after capturing the image using an image capture device; and
enabling display of the image and the classification on a display of the image capture device.

3. The computer-implemented method of claim 2, wherein the image capture device is a mobile computing device or a digital camera.

4. The computer-implemented method of claim 1, wherein storing the image comprises uploading the image to the database using wired communications, wireless communications, or cellular communications.

5. The computer-implemented method of claim 1, wherein the at least one of the plurality of classification modules comprise:
an optical character recognition module configured to recognize text in the image;
a face recognition module configured to recognize a face in the image;
a blur recognition module configured to recognize blur in the image;
a color recognition module configured to recognize a color in the image; or
a saturation recognition module configured to recognize color saturation in the image.

6. The computer-implemented method of claim 1, wherein associating the classification with the image in the database is configured to enable searching the database to identify images associated with a particular classification.

7. The computer-implemented method of claim 1, wherein the classification comprises junk, memories, or data.

8. The computer-implemented method of claim 1, wherein automatically determining the classification comprises:
determining the classification as junk based at least in part on comparing a color saturation metric of the image resulting from applying a saturation recognition module to the image with a color saturation threshold or based at least in part on comparing a blur metric of the image resulting from applying a blur recognition module to the image with a blur threshold;
determining the classification as memories based at least in part on recognizing at least a portion of a face metric in the image resulting from applying a face recognition module to the image and comparing the at least the portion of the face metric to a face threshold; or
determining the classification as data based at least in part on recognizing a text metric in the image resulting from applying an optical character recognition module to the image and comparing the text metric to a text threshold.

9. A system, comprising:
a memory device configured to store instructions; and
a processing device configured to execute the instructions stored in the memory device to:
invoke a plurality of classification modules;
automatically determine a classification corresponding to the image based at least in part on at least one of the plurality of classification modules extracting an image metric from an image and comparing the image metric to a predetermined image metric threshold;
associate the classification with the image in a database; and
enable display of the image and the classification.

10. The system of claim 9, wherein the processing device is configured to execute the instructions stored in the memory device further to:
upload the image to the database after the image is captured using an image capture device; and
enable the display of the image and the classification on a display of the image capture device.

11. The system of claim 10, wherein the image capture device is a mobile computing device.

12. The system of claim 9, wherein the processing device is configured to execute the instructions stored in the memory device further to wirelessly upload the image to the database or upload the image to the database using cellular communications.

13. The system of claim 9, wherein the at least one of the plurality of classification modules comprise:
an optical character recognition module configured to recognize text in the image;
a face recognition module configured to recognize a face in the image;
a blur recognition module configured to recognize blur in the image;
a color recognition module configured to recognize a color in the image; or
a saturation recognition module configured to recognize color saturation in the image.

14. The system of claim 9, wherein the classification comprises junk, memories, or data.

15. The system of claim 9, wherein the processing device is configured to execute the instructions stored in the memory device further to enable searching the database to identify images associated with a particular classification.

16. The system of claim 1, wherein the processing device is configured to execute the instructions stored in the memory device further to:
determine the classification as junk based at least in part on comparing a color saturation metric of the image resulting from applying a saturation recognition module to the image to a color saturation threshold or based at least in part on comparing a blur metric of the image resulting from applying a blur recognition module to the image to a blur threshold;
determine the classification as memories based at least in part on recognizing at least a portion of a face in the image resulting from applying a face recognition module to the image and comparing the at least the portion of the face to a face threshold; or
determine the classification as data based at least in part on recognizing a text metric in the image resulting from applying an optical character recognition module to the image and comparing the text metric to a text threshold.

17. A computer-readable storage medium comprising instructions that, when executed by a processing device, cause the processing device to perform actions comprising:
storing an image in a database after capturing the image using an image capture device;
extracting at least one feature of the image using at least one of a plurality of classification modules;
automatically determining a classification for the image based at least in part on the at least one feature extracted from the image and comparing the at least one feature to a threshold;
associating the classification with the image in the database; and
enabling display of the image and the classification on the image capture device in response to accessing the database.

18. The computer-readable storage medium of claim 17, wherein the instructions, when executed by the processing device, cause the processing device to perform actions further comprising:
receiving the image from the image capture device via a wireless network or a cellular network.

19. The computer-readable storage medium of claim 17, wherein the instructions, when executed by the processing device, cause the processing device to perform actions further comprising:
enable searching the database to identify images associated with a particular classification

20. The computer-readable storage medium of claim 17, wherein the instructions, when executed by the processing device, cause the processing device to perform actions further comprising:
determining the classification as junk based at least in part on comparing a color saturation metric of the image resulting from applying a saturation recognition module to the image with a color saturation threshold or based at least in part on comparing a blur metric of the image resulting from applying a blur recognition module to the image with a blur threshold;
determining the classification as memories based at least in part on recognizing at least a portion of a face metric in the image resulting from applying a face recognition module to the image and comparing the at least the portion of the face metric to a face threshold; or
determining the classification as data based at least in part on recognizing a text metric in the image resulting from applying an optical character recognition module to the image and comparing the text metric to a text threshold.
